(19) United States
(12) Patent Application Publication
(10) Pub. No.: US 2023/0150043 A1
(43) Pub. Date: May 18, 2023

(54) ACTIVELY PRELOADED DRIVE-GUIDEWAY SYSTEM

(71) Applicant: Advanced Machine Works, Inc., Tulsa, OK (US)

(72) Inventor: Larry Don Kirby, Edmond, OK (US)

(21) Appl. No.: 17/987,704

(22) Filed: Nov. 15, 2022

Related U.S. Application Data
(60) Provisional application No. 63/279,466, filed on Nov. 15, 2021.

(51) Int. Cl. B23C 5/26

(52) U.S. Cl. CPC B23C 5/26

(57) ABSTRACT

A machining system for controlling and moving work tools during machining and assembly operations. The system has multiple drive-guide systems that allow work tools to be moved along all three perpendicular Cartesian axes. The drive-guide systems have rollers that are designed to fit and move along rails, thus altering the position of the work tools. A plurality of magnets apply axial pre-load to the rollers, keeping them adequately positioned on the rails. Likewise, a preloaded roller may be used to modify the radial force applied to the drive rollers. Both this radial and axial preload can be adjusted to reduce calibration and tolerance errors throughout machining and assembly processes.

### SUMMARY

The present invention is directed to an apparatus. The apparatus comprises a first frame, a second frame and a plurality of drive assemblies. The first frame comprises a first cylindrical rail and a second cylindrical rail. The second cylindrical rail is parallel to and spaced apart from the first cylindrical rail.

The second frame comprises a plurality of drive assemblies, each comprising a motor and a roller rotatably attached to the motor. Each roller in the plurality of drive assemblies has an external concave profile complementary to a portion of the first cylindrical rail. The second frame is supported on the first frame at each roller of the plurality of drive assemblies.

In another aspect, the invention is directed to an assembly for driving a second frame along a first frame. The first frame comprises vertically offset first and second cylindrical rails. The assembly comprises a first drive member and a first preloading member.

The first drive member comprises a motor, a roller, a bearing assembly, and a position sensor. The roller is coupled to the motor and has a concave profile complementary to a surface of the first cylindrical rail. The bearing assembly comprises inner and outer portions. The inner portion rotates relative to the outer portion and the outer portion does not rotate relative to the second frame. The position sensor is configured to determine a position of the second frame along the first frame.

The first preloading member comprises a roller and a biasing member. The roller has a concave profile complementary to the surface of the second cylindrical rail. The biasing member is configured to force the first preloading member in a direction toward the second cylindrical rail and away from the first cylindrical rail.

In another aspect, the invention is directed to an apparatus having three degrees of linear freedom. The apparatus comprises a first pair of drive-guide assemblies, a second pair of drive-guide assemblies, and a third pair of drive-guide assemblies. The first pair of drive-guide assemblies is adapted to move a work tool in a first direction along a corresponding first set of linear rails. The second pair of drive-guide assemblies is adapted to move a work tool in a second direction along a corresponding second set of linear rails. The third pair of drive-guide assemblies is adapted to move a work tool in a third direction along a corresponding third set of linear rails. Each set of linear rails comprises opposed pairs of first and second rails. The first direction, second direction, and third direction are each perpendicular to each of the other directions.

Each of the drive-guide assemblies comprises a drive roller assembly, a support guide assembly, and a loaded guide assembly. The drive roller assembly comprises a motor and a roller. The roller is coupled to the motor and has a concave radial surface conforming to a first member of a selected one of the first, second, and third linear rails.

The support guide assembly comprises a support roller having a concave radial surface conforming to the first member of a selected one of the first second and third set of linear rails. The loaded guide assembly comprises a loaded roller and a biasing member. The loaded roller has a concave surface conforming to a second member of the selected one of the first, second, and third linear rails. The biasing member is configured to bias the loaded roller towards the second member of the selected one of the first, second, and third set of linear rails and away from the first member of the selected one of the first, second, and third set of linear rails.

### BACKGROUND

Traditional gantry systems are typically large and heavy metal assemblies. The primary purpose of these gantry systems is to control the movement of tools and other attachment pieces throughout machining and/or assembly processes. These gantry systems can be situated overhead or on the ground. Notably, these gantry systems consist of separate drive and guide systems. The separate drive and guide systems result in axes of contact at each location of a drive member. Such separate systems have known limitations in accurate placement of a tool, due to the inherent tendency towards backlash and runout in these systems.

Drive systems are configured to power movement and “drive” whatever is attached to the gantry-often cutting/machining tools or assembly tools. The most common drive systems for large motion platforms are gear systems. These gear systems usually comprise a toothed gear rack and at least one pinion gear configured to fit inside the gear rack. The pinion may be driven by a gearbox, in which many gears may allow the alteration of a gear ratio in order to meet mechanical need. These gear systems experience backlash, however, which results in increased margins of error and higher machining tolerances. As more gears are added, the overall amount of backlash increases. Backlash can cause issues in later phases of production, such as misaligned holes or unanticipated gaps between machined pieces. It is therefore ideal to reduce backlash as much as possible in order to increase accuracy and efficiency.

Some artisans have attempted to eliminate backlash by creating pre-loaded pinion gears that manipulate against each other. However, even preloaded pinions wear over time, resulting in increased gap tolerances and eventually backlash. Therefore, even contemporary pre-loaded pinion gears do not completely eliminate backlash.

Other forms of drive systems have provided half-measures against backlash and often possess other limitations. For example, ball-nut drive systems are common in industrial settings. These ball-nut drive systems typically comprise a threaded rod with a spiral trapezoidal groove, and a plurality of balls that are preloaded inside of the nut to fit inside the grooves and allow the nut to slide up and down the rod. However, these ball-nut drive systems often wear down over time, resulting in increased gaps and, again, backlash. Moreover, these ball-nut systems are limited in size because the necessary rods are only manufactured up to a certain length. Thus, all current drive systems possess notable flaws.

While guide systems are separate from drive systems, they often experience similar backlash and accuracy issues. Guide systems are designed to support the weight of machining or tooling assemblies and provide axial limitations in the movement of the assemblies. These guide systems sit on top of drive systems, providing a second point of contact between the gantry and the machining or assembly tool.

Both box linear guideways and profile linear guideways contain recirculating rollers or balls that allow movement of the gantry system. These recirculating elements, however, often wear down, which leads to backlash and other inaccuracies during operation. Additionally, the surface that these guideways sit on are often unforgiving, resulting in extra forces exerted on the system.

Thus, there is a current industry need for both drive and guide systems that do not experience backlash or other inefficiencies.

### BRIEF DESCRIPTION OF THE DRAWINGS

FIG. 1A is a top front right side perspective view of a gantry. The gantry has a plurality of drive-guide systems which enable the movement of a work tool carried by the gantry along three perpendicular axes. A box is shown from which FIG. 1B is taken.

FIG. 1B is a top front right side perspective view of the highlighted box from FIG. 1A. A portion of the stationary frame is cut away such that the drive-guide system of the present invention may be highlighted.

FIG. 2 is a front right top perspective view of a movable frame having a drive-guide system on each side, with a tool carrying frame carried thereon along a second set of rails. The stationary frame is not shown in FIG. 2.

FIG. 3 is a top right perspective view of the movable frame with the drive-guide system shown. The first set of rails of the stationary frame are truncated, shown only in a short segment below one of the rollers.

FIG. 4 is an exploded side view of a drive roller assembly. Frame elements unrelated to the assembly are represented by the truncated rail and frame beneath the roller and a frame element disposed about the motor.

FIG. 5 is a sectioned view of the drive roller assembly of FIG. 4, with parts re-assembled.

FIG. 6A is a front left perspective view thereof.

FIG. 6B is a back right perspective view thereof.

FIG. 7A is a front left perspective view of a support guide assembly for use with the drive-guide system of the present invention.

FIG. 7B is a back right perspective view thereof.

FIG. 8A is a front left perspective view of a loaded guide assembly.

FIG. 8B is a back right perspective sectioned view thereof, with a sectional view of the biasing assembly in the foreground.

FIG. 9A is a diagrammatic end view of a roller engaging with a rail. An arrow indicates a small amount of force is provided to the roller in the radial direction. The diagram includes an enlarged view of the interface between the roller and rail.

FIG. 9B is a diagrammatic end view of a roller engaging with a rail. An arrow indicates a small amount of force is provided to the roller in the radial direction and a second arrow indicates a small amount of force is provided to the roller in the axial direction. The diagram includes an enlarged view of the interface between the roller and rail, with centers of the roller and rail offset from one another.

FIG. 9C is a diagrammatic end view of a roller engaging with a rail. Arrows indicate a moderate amount of force is provided to the roller in the radial direction and a separate arrow indicates a small amount of force is provided to the roller in the axial direction. The diagram includes an enlarged view of the interface between the roller and rail, with centers of the roller and rail offset from one another.

FIG. 9D is a diagrammatic end view of a roller engaging with a rail. Arrows indicate a large amount of force is provided to the roller in the radial direction and a second set of arrows indicate a moderate amount of force is provided to the roller in the axial direction. The diagram includes an enlarged view of the interface between the roller and rail, with centers of the roller and rail offset from one another.

FIG. 9E is a diagrammatic end view of a different roller engaging with a rail. In this figure, the radius of the concave portion of the roller is less than the radius of the rail. The diagram includes an enlarged view of the interface between the roller and rail.

FIG. 9F is a diagrammatic end view of a different roller engaging with a rail. In this figure, the concave portion of the roller has a profile similar to a gothic arch. The diagram includes an enlarged view of the interface between the roller and rail.

### DETAILED DESCRIPTION

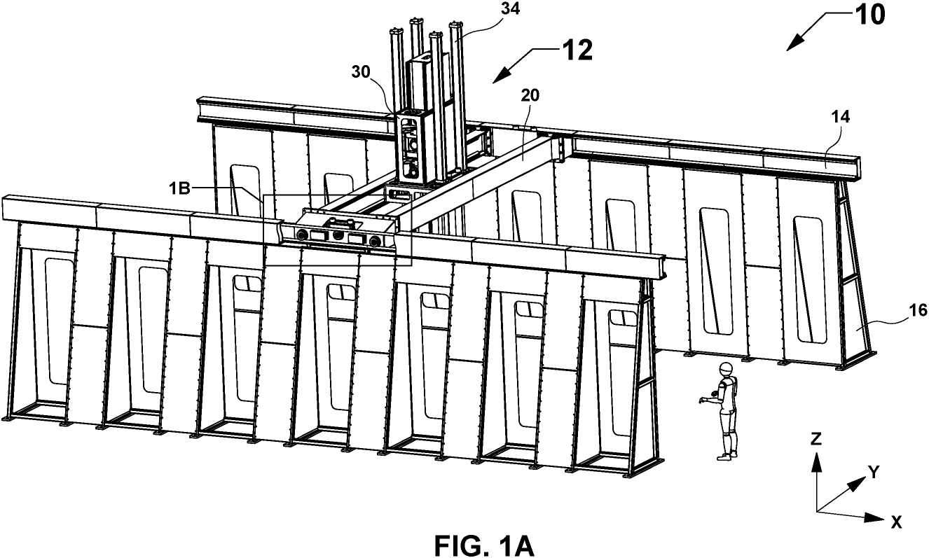

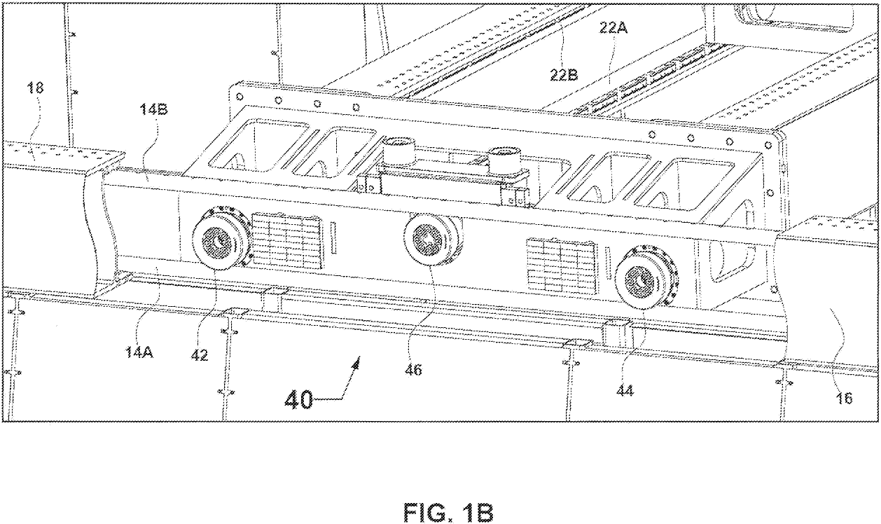

Turning now to the figures, FIG. 1A shows a dynamically preloaded drive-guideway system. The system is placed on a machine 10, which, as shown in the figures, is an overhead gantry. While the gantry 10 will be described herein, it should be understood that the present invention is equally applicable on other axis layouts for machine tools. The drive-guideway system disclosed herein will allow for the precise and repeatable movement of a motion platform. Gantry 10 is shown herein as one applicable axis system for using the drive-guideway system 40 described.

The gantry 10 comprises a work tool assembly 12 which is supported in three dimensions, and rotational about three axes, due to components of the gantry 10. This tool 12 may be a probe, a milling tool, a waterjet cutting head, or any other tool for use in machining, inspection or assembly of large parts. The identity of the tool 12 is not limiting on the present invention.

The gantry 10 comprises a plurality of rails, each of which extends about a longitudinal axis. A first set of rails 14 is supported by one or more stationary frames 16. As shown, the stationary frames 16 are spaced apart, but it should be understood that these frames may be joined at one or more points for added rigidity.

The first set of rails 14 define a first longitudinal direction that is parallel to the longitudinal axis of each of the first set of rails. For the purposes of this disclosure, the first longitudinal direction is defined as “x”, though naming conventions are not limiting on this invention.

As shown, the first set of rails 14 is suspended some distance above the ground by the stationary frame 16, and supported by one or more beams extending in the first longitudinal direction. The first set of rails 14, alternatively, may be placed near to the ground level with a vertical offset allowing the operation of the gantry 10. It should be understood that the first set of rails 14 includes all rails on the gantry 10 which extend in the “x” direction.

A movable frame 20 is supported on the first set of rails 14. The movable frame 20 is movable along the first set of rails 14 in the first longitudinal direction. The movable frame 20 comprises a second set of rails 22. The second set of rails 22 define a second longitudinal direction, wherein the second longitudinal direction is perpendicular to the first longitudinal direction. For the purposes of this disclosure, the second longitudinal direction is defined as “y”.

As shown, the first longitudinal direction and second longitudinal direction define a plane which is parallel to a surface of the ground. A third longitudinal direction, therefore, is defined as “z” and is vertical - that is - perpendicular to both the first and second longitudinal directions.

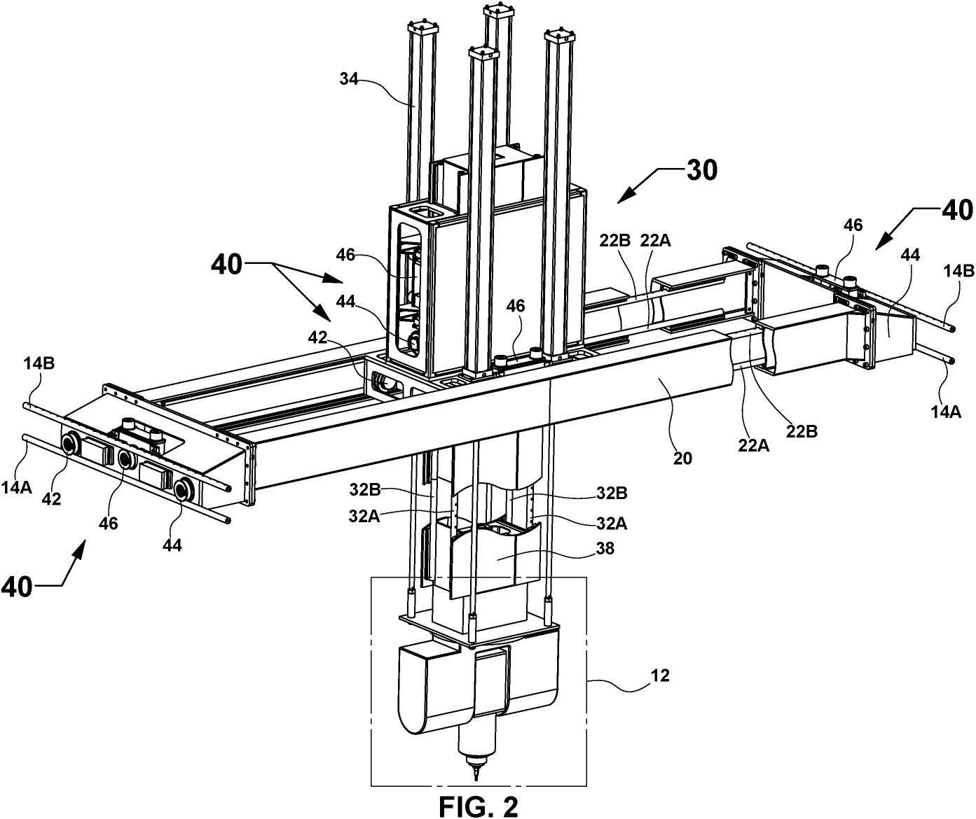

A tool holding frame 30 is supported on the movable frame 20. The tool holding frame 30 comprises a third set of rails 32 (FIG. 2). The tool holding frame is actuated by one or more counterbalancing cylinders 34 which drive the work tool 12 in the z direction. Elements of the tool holding frame 30 as it moves relative to the movable frame 20 are better shown on FIG. 2.

FIG. 1B shows portions of the stationary frame 16 cut away so that the first set of rails 14 may be shown. The first set of rails 14 on each side of the stationary frame 16 comprises a bottom rail 14a and a top rail 14b. A matching top and bottom rail are disposed on the stationary frame at an opposite end of the movable frame 20. Preferably, the top rail 14b and bottom rail 14a are parallel and both situated with their longitudinal axes within a vertical plane. The first set of rails 14 are supported on the stationary frame 16 at structural beams 18.

The movable frame 20 comprises a drive-guide system 40 disposed at each of its ends. The drive-guide system 40 interacts with the first set of rails 14 to support and drive the movement of the movable frame 20 (and thus the tool 12) in the x direction. Likewise, a drive-guide system 40 is disposed on each side of the tool holding frame 30, and moves the tool holding frame in the y direction along the second set of rails 22. And further, a drive-guide system 40 is fixed in position on a tool frame 38 relative to the work tool 12 and interacts with the third set of rails 32 on the tool-holding frame 30, allowing movement in the z direction.

Each drive-guide system 40 is substantially identical, with a set of rollers, as described below, which interact with a selected one of the first, second and third set of rails 14, 22, 32 to move the work tool 12 in a corresponding x, y, or z direction.

As best shown in FIGS. 1B and 2, a pair of drive-guide systems 40 are on opposed sides of the movable frame 20, the tool holding frame 30, and on the tool frame 38. One or both of the pair of drive-guide systems 40 may include one or more magnets 36. The magnets 36 act to provide a force to the frame 20, 30, 38 which is transverse to the length of the set of rails 14, 22, 32 on which the respective frame is carried.

While the term “frame” is used to describe the elements on a gantry 10, it should be appreciated that each frame which provides a separate degree of freedom to the work tool 12 is accurately described as an “axis stage”. In a gantry 10, each axis stage may indeed be a separate frame. However, other, non-frame structures may be used with other machine tools to provide degrees of linear freedom to a work tool 12. These alternative structures may also utilize the drive-guide system 40 of the present invention without departing from the spirit thereof.

The drive-guide system 40 comprises a support guide assembly 42, a drive roller assembly 44, and a loaded guide assembly 46. Each of the support guide assembly 42, drive roller assembly 44, and loaded guide assembly 46 are shown in the figures with reference to a single side of the movable frame 20, but substantially identical drive-guide systems 40 are provided with the tool frame 38 and the tool holding frame 30. Thus, an identical set of assemblies 42, 44, 46 is provided at a second end of the movable frame 20 and engage with the first set of rails 14 disposed on that portion of the secondary frame 16. Preferably, the movable frame 20 is only supported at the drive-guide system shown, and does not have additional guide members disposed elsewhere on the gantry 10 for supporting the movable frame 20.

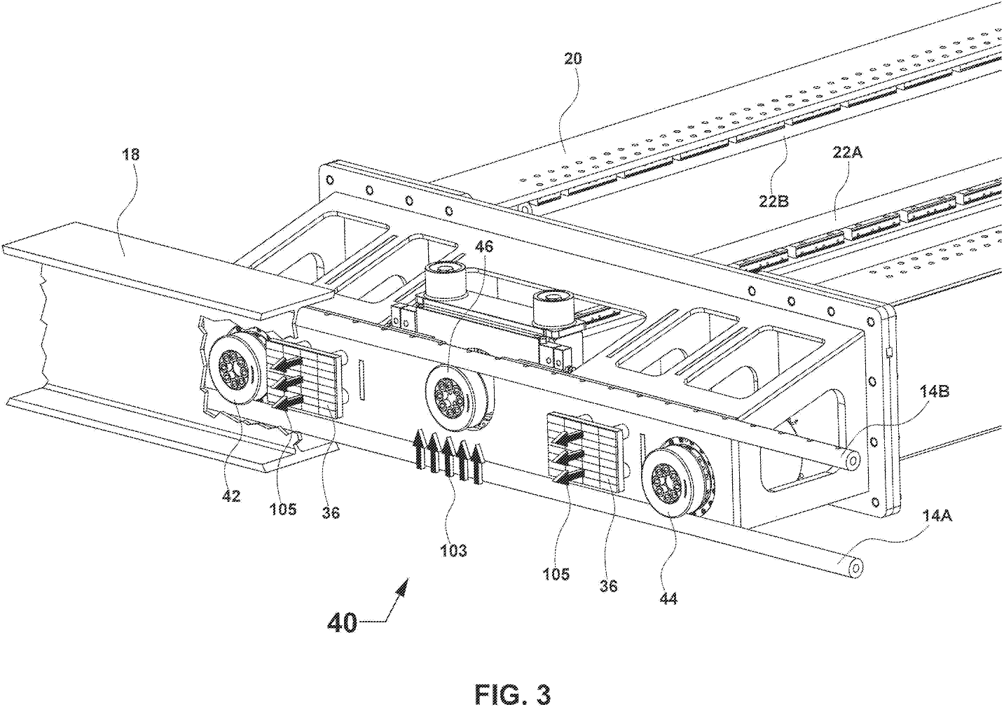

As shown in FIG. 3, a pair of magnets 36 is carried on a single drive-guide system 40 of the pair carried by the movable frame 20. However, it should be understood that a magnet 36 could be carried on each of the pair of drive-guide systems 40, so long as the resultant magnetic forces are additive. For example, the magnets 36 shown in FIG. 3 may be an attractive force, pulling the movable frame 20 towards the portion of the stationary frame 16 on which the rails are carried. Any magnet 36 on the opposite one of the pair of drive-guide systems 40 should provide a repulsive force relative to its portion of the stationary frame 16.

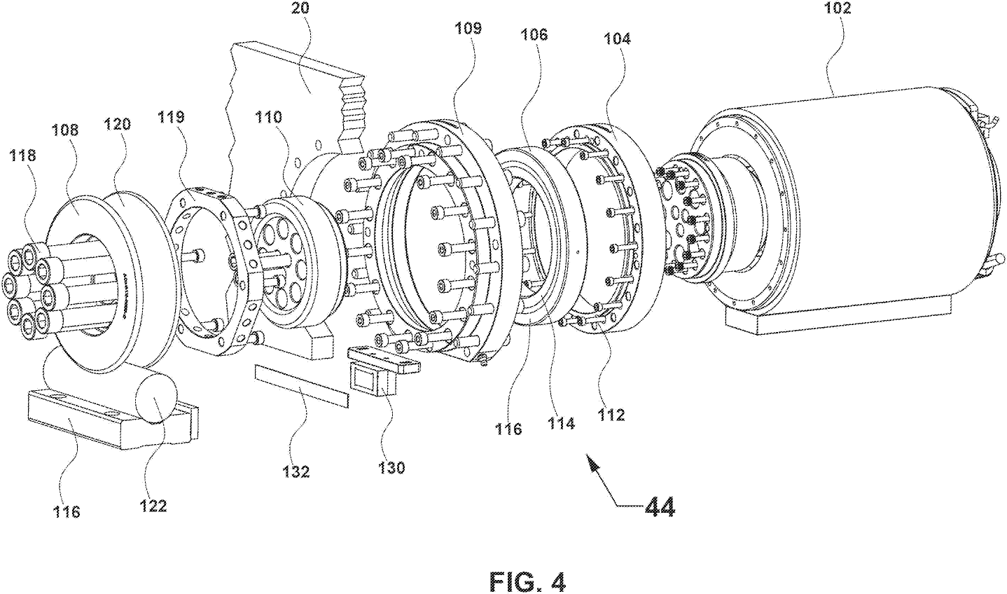

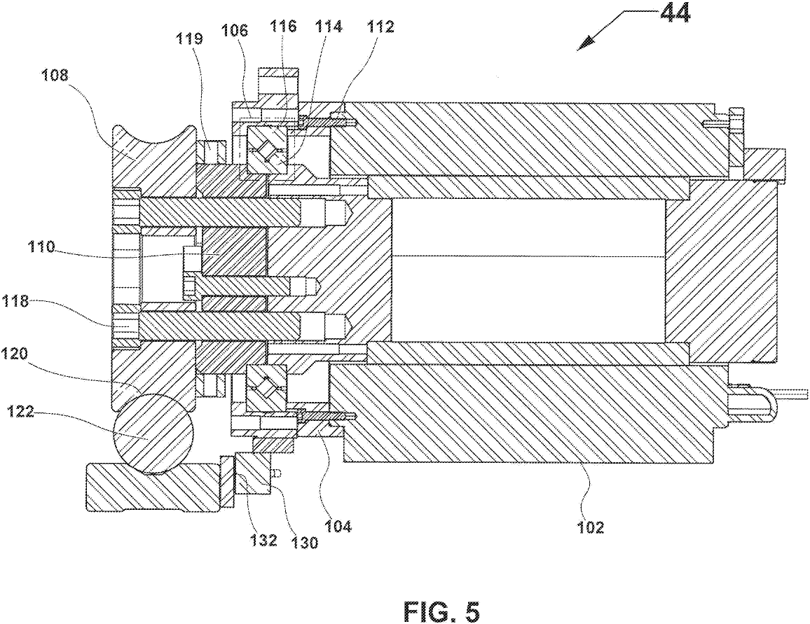

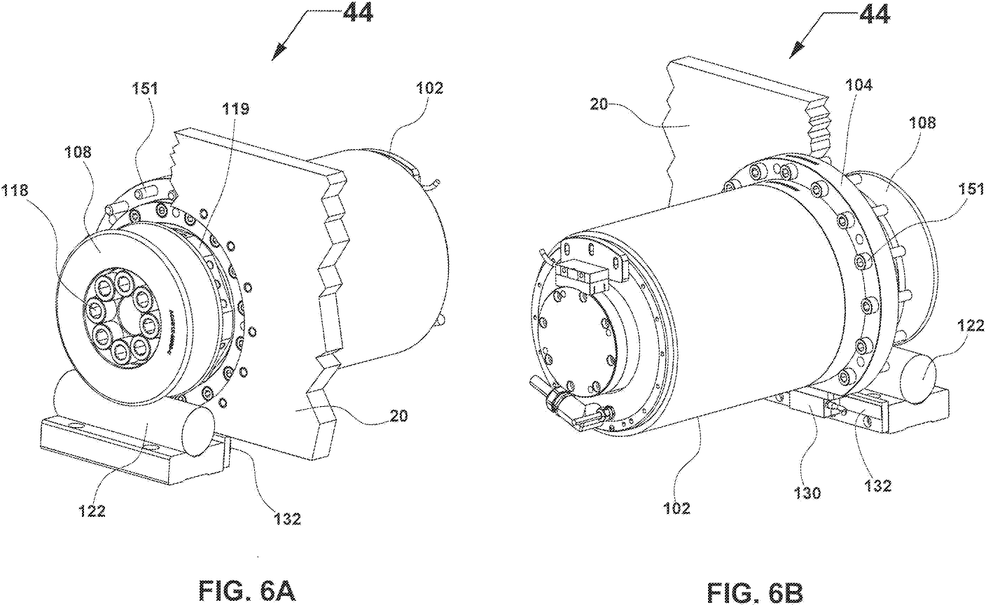

With reference to FIGS. 4, 5, and 6A and 6B, an example drive roller assembly 44 is shown. The drive roller assembly 44 comprises a motor 102, an adaptor 104, a bearing assembly 106, and a roller 108.

The motor 102 may be a rotational drive motor having one or more intermediate rotor pieces 110 between the motor 102 and the roller 108. The motor 102 is mounted on the frame upon which the drive-guide system is supported, here, the movable frame 20. The adaptor 104 is connected to non-rotating components of the motor 102 and is sized to connect via pins 112 to the bearing assembly 106.

The bearing assembly 106 has a rotating race or portion 114 and a non-rotating race or portion 116. Preferably, the bearing assembly 106 is a cross-roller bearing. In a cross-roller bearing, rollers between the rotating 114 and non-rotating 116 portions of the bearing assembly 106 alternate at a ninety degree angle to adjacent rollers within a substantially “v” shaped groove. This allows the bearing assembly 106 to have radial and axial loading.

The non-rotating portion 116 is connected to the adaptor 104. The rotating portion 114 is connected to the motor 102 at its intermediate rotor pieces 110. The rotating 114 and non-rotating 116 portions abut at a sliding surface, where ball bearings, cylinder bearings or other bearing devices (not shown) disposed between the portions 114, 116 allow for relative rotation between them. Preferably, the bearing assembly 106 is preloaded and constrained in the axial direction to provide accurate and repeatable linear motion.

The drive roller assembly 44 is preferably connected to the movable frame 20 at a position close to its end, with as little of a drive roller assembly 44 extending from the frame 20 as possible. As shown in FIGS. 1B, 2 and 3, the roller 108 extends just beyond the end of the movable frame 20 to engage with the first set of rails 14. In this way, the length of any moment arm is limited.

The roller 108 is attached to the rotating section 114 and other rotating components 110 by large pins 118. These pins 118 should be of sufficient strength and length to carry forces exerted on the roller 108 by the weight of the frame it carries. For example, a plurality of drive roller assemblies 44 adapted to move the movable frame 20 along the first set of rails should be able to carry its weight, even as the tool holding frame 30 is moved along the second set of rails 22 to different locations.

A ring 119 is provided at which a micrometer (not shown) or other instrument may be attached to measure the runout of any individual drive roller assembly 44. Further, an encoder 130 may be carried by a flange 109 on the stationary bearing of the bearing assembly 106 to measure the position of the drive roller assembly 44 along a scale 132 which is attached to an element of the frame supporting the rail 14, 22, 32 along which the drive roller assembly 44 is moving.

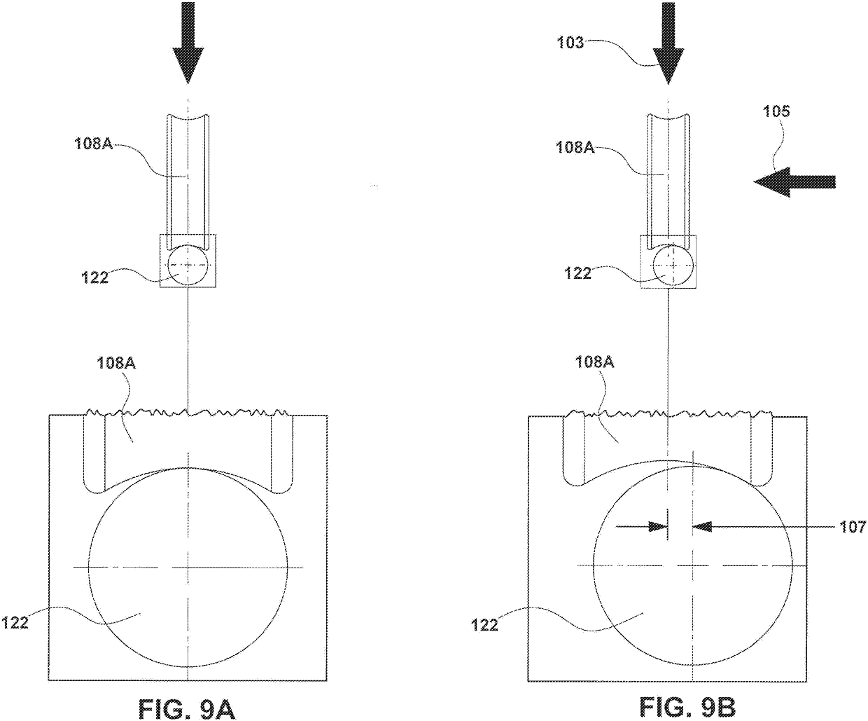

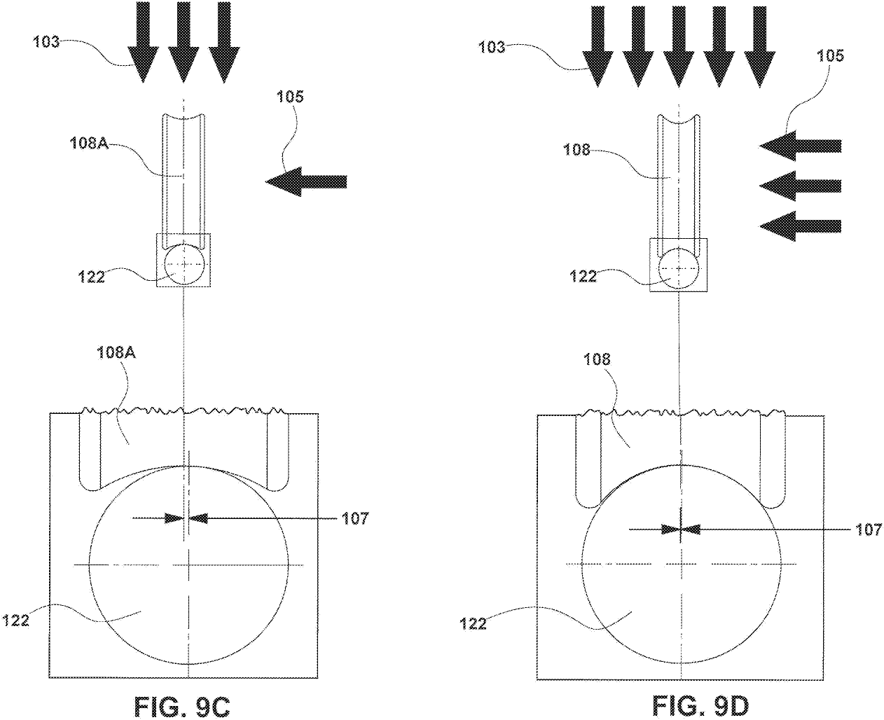

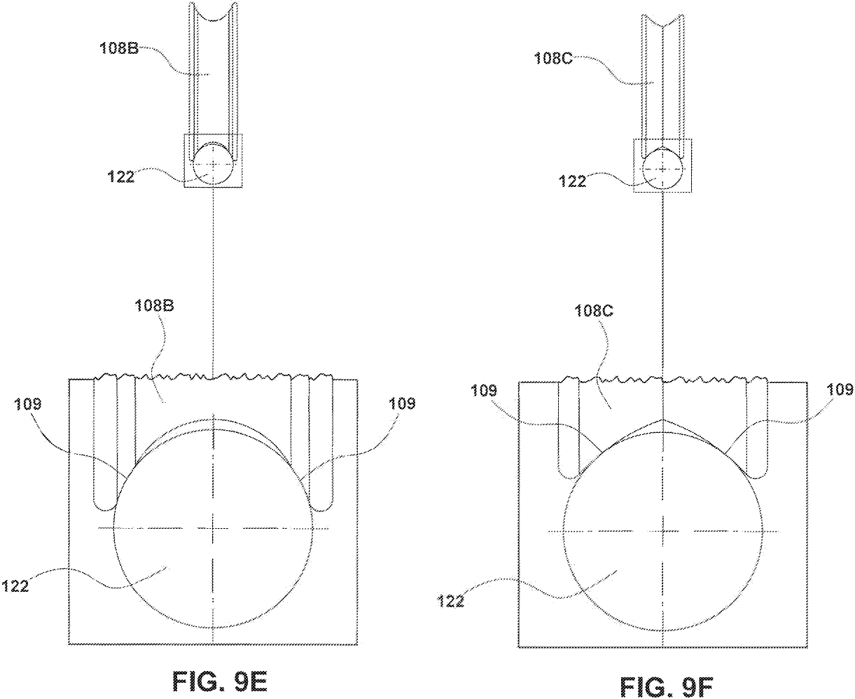

The roller 108 has a concave surface 120 which largely conforms to the cylindrical rail 122 shown. The cylindrical rail 122 shown here may represent the first 14, second 22 or third 32 set of rails, and is sectioned for clarity. If magnets 36 are in use, the roller 108 will not center on the cylindrical rail 122, but rather will be offset due to the magnetic force associated with the field of the magnets 36. (FIGS. 9B-9D) Such force reduces wear on the roller 108 due to oscillation or vibration and allows the concave surface 120 to center on the cylindrical rail 122 at a location offset from the top of the rail.

The amount of axial force 105 (FIGS. 9B-9D) provided by the magnets 36 may be precisely adjusted by adjusting a distance between the magnet itself and attractive frame elements. For example, bolts may be provided with each magnet 36, adjusting a position of the magnet relative to the nearby frame (such as stationary frame 16).

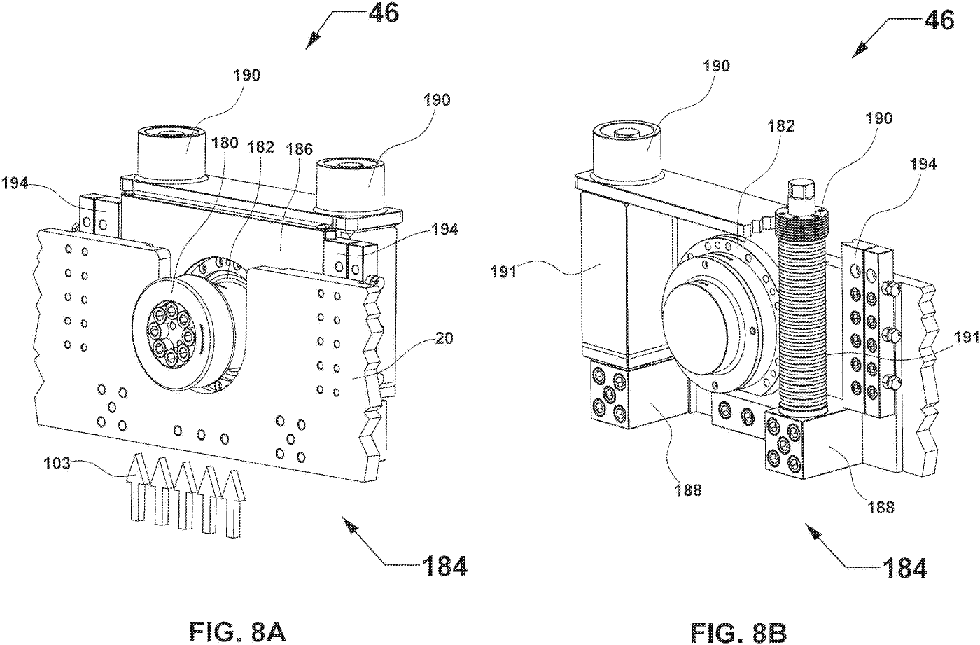

An example of how pre-loaded forces affect the position of the roller 108 is shown in FIGS. 9A-9D. Forces 103 are perpendicular to both the axis of the roller 108, 108A and the length of the rail 122. These will be referred to as “radial forces”, and may be added by manipulation of the loaded guide assembly 46 (FIGS. 8A-8B). Forces 105 are perpendicular to the length of the rail 122 but parallel to the axis of the roller 108. Forces 105 are provided by the magnets 36, and will be referred to as “axial forces”.

As shown in FIG. 9A, when only radial force is provided, the roller 108A is centered on the rail 122. When axial force is added as shown in FIG. 9B, the roller 108A is offset from the center of the rail 122 by a distance 107. Because these forces 103, 105 are equal, the offset distance 107 will tend to be large as rail 122 moves up the “ramp” of the roller 108A. As shown in FIGS. 9C-9D, axial forces that are less than the radial forces applied result in a smaller offset distance 107. Consistent positioning of the contact points between the rail 122 and roller 108 will reduce rubbing between the two, cutting down on wear and improving positional accuracy.

In FIGS. 9A-9C, roller 108A is shown, having a profile which less particularly matches the rail 122. This roller 108A may be suitable for the loaded roller assembly 46 or support guide assembly 42. In these figures, this roller 108A is shown for illustrative purposes, the tight tolerances of roller 108 being more difficult to visualize. In FIG. 9D, the profile of roller 108 more closely matches the rail 122, resulting in a steeper ramp and more precise positioning

The relative profiles of FIGS. 9A-9D are preferable to both the spherical roller 108B of FIG. 9E and the gothic arch style roller 108C of FIG. 9F. These profiles provide for precise axial positioning in an initial position because of the two points of contact. However, as wear occurs, it becomes less reliable. Therefore, systems employing two points of contact between a rail 122 and roller 108 will require lubrication, which is practically disadvantageous and unsuitable for a roller which operates to drive the motion of various frames within the gantry 10.

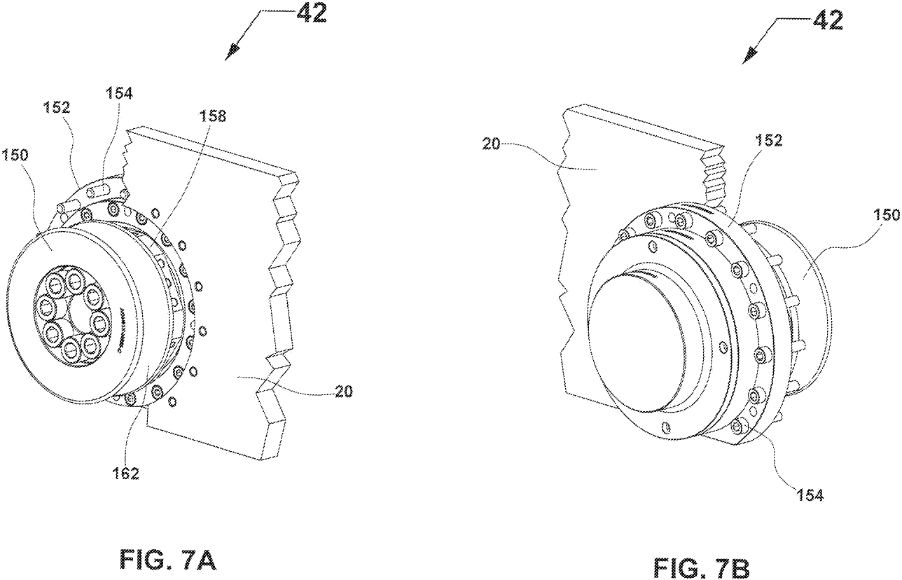

With reference to FIGS. 7A and 7B, the support guide assembly 42 is shown, without the frame elements around it. As shown in FIG. 1B, the support guide assembly 42 is secured to a frame element (such as the movable frame 20). The support guide assembly 42 comprises a roller 150 and a bearing assembly 152. The bearing assembly 152 comprises a movable and non-movable portion, with ball or roller bearings disposed therebetween suitable for repeated rotation. The bearing assembly 152 is secured to the movable frame by a plurality of pins 154. Likewise, the roller 150 is secured to the movable portion of the bearing assembly 152 by a plurality of pins 156. A ring 158 may be placed proximate the roller 150 such that a micrometer or other measurement device may detect runout in the roller 150 and adjust accordingly.

The support guide assembly 42 has a flat portion 160 at which the assembly may be attached to frame elements. As with the roller 108 of drive roller assembly 44, roller 150 has a concave surface 162 which conforms to an outer surface of a cylindrical rail.

While one support guide assembly 42 is shown as a part of the drive-guide system 40, multiple support guide assemblies 42 may be utilized to provide additional support to the particular frame being guided. It should be appreciated that if more than one is used, the additional support guide assemblies should be carefully aligned such that the drive-guide system will interact with the applicable set of rails 14, 22, 32 at each point. Alternatively, as in the Figures, one and only one support guide assembly 42 is used with each drive roller assembly 44 to provide two and only two points of contact on the lower rail 14a.

It may be preferable to allow the bearing assembly 152 of the support guide assembly 42 to float axially - that is, in a direction along the longitudinal axis of the assembly 42 and perpendicular to each of the first set of rails 14. The drive roller assembly 44 will be fixed in axial position and not allowed to float, which will maintain a preferred position of the assemblies 42, 44 relative to the rail. Allowing axial float in the roller 150 through the bearings 152 allows for mounting on imperfect surfaces without the drive-guide system 40 getting in a bind.

With reference to FIGS. 1B, 2, 8A and 8B, the loaded guide assembly 46 engages a top rail 14b. The top rail 14b is secured to the stationary frame 16. Thus, any force applied by the drive-guide assembly 40 to the top rail 14b will tend to press the support guide assembly 42 and the drive roller assembly 44 into the lower rail 14a. This “preload” on the set of rails 14 provides for consistent positioning of roller 150 and roller 108. This preload force is shown as force 103 in FIGS. 9A-9D.

The loaded guide assembly 46 comprises a roller 180, a bearing assembly 182, and a biasing assembly 184. The bearing assembly 182 is allowed to float axially for the same reasons as bearing assembly 152. The non-moving portion of the bearing assembly 182 is fixed to the biasing assembly 184, which allows the selective positioning of the roller 180 relative to the movable frame 20 by adjusting the distance between the engagement point of roller 180 and that of rollers 108, 150.

The biasing assembly 184 comprises a plate 186, a frame attachment point 188, and one or more pre-load nuts 190. The loaded guide assembly 46 is attached to the movable frame 20 (or other frame 30, 38 as the case may be) at the attachment point 188. Adjustment of the one or more nuts 190 adjusts the distance between the plate 186 and the attachment point 188. Preferably, a plurality of springs 191, such as disc springs, are utilized to provide the biasing force. Linear guideways 194 allow the plate 186 to slide, which carries the bearing assembly 182 and roller 180 to provide radial force.

As the roller 180 and bearing assembly 182 are movable with and supported on the plate 186, adjustment of the nuts 190 also adjusts the resultant force between the roller 180 and rollers 108, 150. Thus, adjusting the nuts 190 to force the roller 180 away from the lower rail 14a increases the load applied to the first set of rails 14, or radial force 103 (FIG. 9D).

As with the roller 108 of drive roller assembly 44 and roller 150 of the support assembly 42, roller 180 has a concave surface 192 which conforms to an outer surface of a cylindrical rail. In this instance, the cylindrical rail is upper rail 14b.

For drive-guide systems 40 engaging the first set 14 and second set 22 of rails, the biasing assembly adjusts a “z” distance between the roller 180 and rollers 108, 150. For drive-guide systems 40 engaging the third set of rails, the biasing assembly 184 adjusts either an “x” or “y” distance between these elements, depending upon the orientation of the drive-guide systems on the tool frame 38.

Components, such as the rollers 108, 150, 180, rings 119, 158, bearing assemblies 106, 152, 182 and the like may be identical between the described assembly, or may include differences between them without departing from the spirit of the invention. For example, the roller 180 of the loaded guide assembly 46 may be shaped similarly to roller 108A as shown in FIG. 9A, or it may be identical to roller 108. Roller 180 may conform less to the rail 122 (or 14b) at the loaded guide assembly as axial movement is controlled by other elements and some axial float may be desired to avoid binding.

In addition to the linear systems above, a radial adjustment mechanism may use similar rollers and rails. In some applications, such a radial adjustment mechanism may be disposed on the tool frame 38. However, depending upon the type of apparatus, linear guides may be provided between rotary systems.

The radial adjustment mechanism comprises a radial drive motor and one or more bearing assemblies. Each of the radial drive motor and the bearing assemblies are disposed about a disc having a circular outer profile. Rollers are provided with each of the radial drive motor and bearing assemblies which engage the disc. It is preferable to have three points of contact on the disc - the radial drive motor and bearing assemblies are approximately 120 degrees apart.

The drive motor may be mounted on a radial pre-load system 210 which provides force to the disc to ensure a proper frictional connection between the rollers and the disc.

The tool frame may have three or more radial adjustment mechanisms. For example, a first mechanism a rotates a bottom portion of the tool frame 38 about a substantially vertical axis. The second mechanism rotates the tool 12 about a substantially horizontal axis.

The third adjustment mechanism rotates the tool 12 relative to the tool frame 38 itself. The third adjustment mechanism is rotatable about an axis which is perpendicular to the substantially horizontal axis of the second mechanism, but its orientation relative to the directions “x”, “y”, and “z” is adjusted due to the operation of the second adjustment mechanism. Additional degrees of rotational freedom may be added, and various arrangements may be utilized depending upon the type of machine.

The gantry 10 thus can manipulate the tool 12 accurately along three perpendicular axes, and can rotate the tool 12 about three additional axes.

Given that the above system does not utilize any gear boxes nor does it provide a guide system separated from its drive system, backlash and runout are both significantly reduced. Total volumetric accuracies in large machine tools utilizing existing guide/drive systems may be as large as 0.03″ or 750 microns. The present gantry 10, due to the near-elimination of backlash and runout, may be able to achieve accuracy that is one hundred times greater, with total volumetric accuracy in the five to fifteen micron range.

Used in this specification and the claims, the phrase “complementary to the profile” or “conforms to” when discussing the interface of the cylindrical rail and roller 108,150,180, means that the roller is optimized to fit the rail. For example, a rail having a diameter of approximately five centimeters has an ideal complementary concavity on an associated roller. If the diameters too closely match, frictional resistance between the rollers and rail will cause problems. Conversely, if the diameters are too disparate, axial position of the roller relative to the rail will not be maintained, which can cause inaccuracies and unfavorable stress profiles.

If the diameter of the concavity of the roller and rail substantially match, more resistance to lateral (axial) movement will exist, and load capacity will increase. At a 14 degree roller pressure angle on a 49.983 millimeter rail, a 2.91 millimeter gap would exist between the roller and the rail, as the roller would have a concavity with a diameter of 75 mm.

Analytical tools reveal a best mode for a 49.983 millimeter rail being a roller with a 50.1 millimeter edge diameter. The roller pressure angle in this instance is 22.5 degrees with a gap of one one-thousandth of an inch between the rail and roller. This tight tolerance effectively reduces lateral movement and wear. While this is the best relationship between rail and roller diameter, it should not be construed as limiting. The example shown with a 75 millimeter diameter concavity may work in many applications, without departing from the scope and spirit of these claims.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

The invention claimed is:

1. An apparatus, comprising:
a first frame comprising:
a first cylindrical rail, and
a second cylindrical rail, parallel to and spaced apart from the first cylindrical rail; and
a second frame comprising:
a plurality of drive assemblies, each drive assembly comprising:
a motor; and
a roller rotatably attached to the motor;
wherein each roller in the plurality of drive assemblies has an external concave profile complementary to a portion of the first cylindrical rail; and
wherein the second frame is supported on the first frame at the roller of the plurality of drive assemblies.

2. The apparatus of claim 1 in which the first cylindrical rail and second cylindrical rail are horizontally displaced at opposite ends of the second frame.

3. The apparatus of claim 1 in which the first cylindrical rail and second cylindrical rail are vertically displaced at the same end of the second frame.

4. The apparatus of claim 3 further comprising:
a preloading roller having an external concave profile complementary to a portion of the second cylindrical rail; and
a biasing member configured to selectively press the preloading roller against the second cylindrical rail.

5. The apparatus of claim 1 in which the first cylindrical rail and second cylindrical rail are characterized as first and second first-direction cylindrical rails and wherein:
the second frame comprises:
a first second-direction cylindrical rail; and
a second second-direction cylindrical rail, parallel to and spaced apart from the first second-direction cylindrical rail;
and further comprising:
a third frame comprising:
a plurality of drive assemblies, each drive assembly comprising:
a motor; and
a roller rotatably attached to the motor;
wherein each roller in the plurality of drive assemblies has an external concave profile complementary to a portion of the first second-direction cylindrical rail.

6. The apparatus of claim 5 in which the first and second first-direction cylindrical rails are perpendicular to the first and second second-direction cylindrical rails.

7. The apparatus of claim 5 further comprising a tool-carrying frame, in which the tool-carrying frame is configured to:
be moved vertically relative to the third frame;
be moved in the second-direction by the plurality of drive assemblies disposed on the third frame; and
be moved in the first-direction by the plurality of drive assemblies disposed on the second frame.

8. The apparatus of claim 7 in which the tool-carrying frame comprises a work tool.

9. The apparatus of claim 8 in which the work tool is a milling head.

10. The apparatus of claim 1 further comprising a magnet disposed on the second frame, wherein the magnet dynamically biases the second frame towards the first first-direction cylindrical rail.

11. The apparatus of claim 1 in which the first frame comprises first and second frame elements, wherein the second frame is disposed between the first frame element and the second frame element, and in which the first cylindrical rail and second cylindrical rail are vertically displaced and supported on the first frame element.

12. The apparatus of claim 11 in which the second frame element comprises:
a third cylindrical rail; and
a fourth cylindrical rail;
wherein the third and fourth cylindrical rails are parallel to the first and second cylindrical rails; and
wherein at least a portion of the third cylindrical rail is complementary to each roller in the plurality of drive assemblies.

13. The apparatus of claim 12 in which the second frame is movable along the first cylindrical rail and the third cylindrical rail by the plurality of drive members.

14. The apparatus of claim 1 wherein at least one of the plurality of drive members comprises a position sensor configured to determine a position of the second frame relative to the first frame.

15. An assembly for driving a second frame along a first frame, the first frame comprising vertically offset first and second cylindrical rails, the assembly comprising:
a first drive member comprising:
a motor;
a roller coupled to the motor, the roller having a concave profile complementary to a surface of the first cylindrical rail;
a bearing assembly, in which the bearing assembly comprises inner and outer portions, wherein the inner portion rotates relative to the outer portion and the outer portion does not rotate relative to the second frame; and
a position sensor, configured to determine a position of the second frame along the first frame; and
a first pre-loading member, comprising:
a roller having a concave profile complementary to a surface of the second cylindrical rail; and
an adjustable biasing member configured to force the first pre-loading member in a direction toward the second cylindrical rail and away from the first cylindrical rail.

16. The assembly of claim 15 further comprising:
one or more support rollers, wherein the one or more support rollers have a concave profile complementary to the surface of the first cylindrical rail.

17. The assembly of claim 15 further comprising:
a magnet configured to selectively bias the second frame toward the first frame in a direction perpendicular to a length of the first and second cylindrical rails.

18. An assembly comprising:
the assembly of claim 15, wherein the assembly is characterized as a first assembly and is disposed at a first end of the second frame; and
a second assembly for driving the second frame along the first frame, wherein the first frame comprises a second portion, the second portion having vertically offset third and fourth cylindrical rails, the second assembly disposed at a second end of the second frame, the second assembly comprising:
a second drive member comprising:
a motor;
a roller coupled to the motor, the roller having a concave profile complementary to a surface of the third cylindrical rail;
a bearing assembly, in which the bearing assembly comprises inner and outer portions, wherein the inner portion rotates relative to the outer portion and the outer portion does not rotate relative to the second frame; and
a position sensor, configured to determine a position of the second frame along the first frame; and
a second pre-loading member, comprising:
a roller having a concave profile complementary to a surface of the fourth cylindrical rail, and
an adjustable biasing member configured to force the second pre-loading member in a direction toward the fourth cylindrical rail and away from the third cylindrical rail.

19. An apparatus having three degrees of linear freedom, the apparatus comprising:
a first pair of drive-guide assemblies adapted to move a work tool in a first direction along a corresponding first set of linear rails;
a second pair of drive-guide assemblies adapted to move a work tool in a second direction along a corresponding second set of linear rails; and
a third pair of drive-guide assemblies adapted to move a work tool in a third direction along a corresponding third set of linear rails;
wherein each set of linear rails comprises opposed pairs of first and second rails;
wherein the first direction, second direction, and third direction are each perpendicular to the other two directions; and wherein each of the drive-guide assemblies comprises:
a drive roller assembly comprising:
a motor;
a roller coupled to the motor and having a concave radial surface conforming to a first member of a selected one of the first, second and third set of linear rails;
a support guide assembly comprising a support roller having a concave radial surface conforming to the first member of the selected one of the first, second and third set of linear rails; and
a loaded guide assembly comprising:
a loaded roller having a concave radial surface conforming to a second member of the selected one of the first second and third set of linear rails; and
an adjustable biasing member configured to bias the loaded roller towards the second member of the selected one of the first, second and third set of linear rails and away from the first member of the selected one of the first, second and third set of linear rails.

20. The apparatus of claim 19 further comprising:
a first magnet disposed at one and only one of the first pair of drive-guide assemblies, the first magnet emitting a first magnetic field; and
a frame element supporting the first set of rails;
wherein the first magnet is configured to be adjustable in position relative to the frame element, thereby adjusting a biasing force applied by the first magnetic field.
